(19) United States
(12) Patent Application Publication
(10) Pub. No.: US 2001/0017990 A1
(43) Pub. Date: Aug. 30, 2001

(54) Process cartridge and image forming apparatus

(76) Inventors: Toru Oguma, Mishima-shi (JP); Kazushi Watanabe, Mishima-shi (JP); Akiyoshi Yokoi, Shizuoka-ken (JP)

Correspondence Address: FITZPATRICK CELLA HARPER & SCINTO, 30 ROCKEFELLER PLAZA, NEW YORK, NY, 10112, US

(21) Appl. No.: 09/758,285

(22) Filed: Jan. 12, 2001

(30) Foreign Application Priority Data
Jan. 13, 2000 (JP) 2000-004978
Jan. 5, 2001 (JP) 2001-000864

(51) Int. Cl. G03G 15/08

(52) U.S. Cl. 399/27; 399/61; 399/111

(57) ABSTRACT

A process cartridge detachably mountable to a main assembly of an electrophotographic image forming apparatus includes an electrophotographic photosensitive member, a developing member, a developing device frame including a first frame portion supporting the developing member and a second frame portion having a developer accommodating portion, first and second spaced apart electroconductive portions to permit the main assembly to detect a remaining amount of developer in the process cartridge, a cartridge contact disposed in the second frame portion and electrically connectable to the main assembly when the cartridge is mounted to the main assembly, a contacting electrode disposed in the second frame portion and electrically connected with the cartridge contact, and a first electroconductive portion contact disposed in the first frame, electrically connected with the first electroconductive portion, and electrically contacting the contacting electrode at a connecting portion between the first and second frames portions.

### FIELD OF THE INVENTION AND RELATED ART

The present invention relates to a process cartridge and an electrophotographic image forming apparatus to which a process cartridge is detachably mountable.

Here, the electrophotographic image forming apparatus may be an electrophotographic copying machine, an electrophotographic printer (a LED printer, a laser beam printer or the like), an electrophotographic printer type facsimile machine, an electrophotographic printer type word processor or the like.

The process cartridge may contain as a unit an electrophotographic photosensitive member and at least one of a charge member, a developing member and a cleaning member, the unit being detachably mountable to the main assembly of the electrophotographic image forming apparatus. The process cartridge make contain as a unit an electrophotographic photosensitive member and at least a developing member, the unit being detachably mountable to a main assembly of the electrophotographic image forming apparatus.

In an electrophotographic image forming apparatus using the electrophotographic image forming process, use has been made with the process cartridge type in which the process cartridge comprises as a unit the electrophotographic photosensitive member and process means actable on the electrophotographic photosensitive member, the unit being detachably mountable to the main assembly of the electrophotographic image forming apparatus. With the use of the process cartridge type, the maintenance operation can be carried out in effect by the users without necessity of relying on serviceman, and therefore, the operativity is improved. Therefore, the process cartridge type is widely used in the field of electrophotographic image forming apparatus.

Furthermore, an example of a frame of a conventional process cartridge is as follows. The frame includes a developer chamber and a developer accommodating container, the developer chamber is provided with developing means including a developing member in the form of a developing roller for supplying the developer to an electrostatic latent image formed on an electrophotographic photosensitive member, and a developer layer thickness regulating member in the form of a developing blade for regulating a thickness of a layer of the developer carried on the developing roller, and the developer accommodating container including a developer accommodating portion provided with a developer feeding member. The developing device frame is coupled with a cleaning frame to which the electrophotographic photosensitive member, the cleaning member and a charge member are mounted.

It is conventional to use a developer amount detection electrode comprising a first electroconductive portion and a second electroconductive portion which constitute a capacitor in the developing device frame as a means for detecting a remaining amount of the developer in the process cartridge. A voltage is applied between the first electroconductive portion and the second electroconductive portion, and the change of the amount of the developer is detected as a change in the electrostatic capacity between the first electroconductive portion and the second electroconductive portion. In a process cartridge having such a type of detecting system, a connection electrodes for supplying a developer amount detection bias to the detection electrode from the main assembly of the electrophotographic image forming apparatus and for supplying the detection bias to the main assembly of the electrophotographic image forming apparatus, are provided.

When the process cartridge is mounted to the main assembly of the image forming apparatus, the connection electrode provided in the process cartridge is electrically connected with the connection electrode provided in the main assembly of the image forming apparatus, thereby establishing electrical connection therebetween. By doing so, the developer amount detecting means becomes operable.

Depending on the structure of the main assembly of the image forming apparatus and/or congregation of the process cartridge, the mounting position of the connection electrode may be limited. In such a case, during the process of assembling the process cartridge or the developing frame, it is necessary to electrically connect divided connection electrodes with each other.

### SUMMARY OF THE INVENTION

Accordingly, it is a principal object of the present invention to provide a process cartridge and an electrophotographic image forming apparatus to which the process cartridge is detachably mountable in which the electrical connection in the process cartridge is assured.

It is another object of the present invention to provide a process cartridge and an electrophotographic image forming apparatus to which the process cartridge is detachably mountable, in which the voltage received by the process cartridge from the main assembly of apparatus can be supplied assuredly to the right member.

It is a further object of the present invention to provide a process cartridge and an electrophotographic image forming apparatus to which the process cartridge is detachably mountable, in which the electrical connection is assured across frames.

It is a further object of the present invention to provide a process cartridge detachably mountable to a main assembly of an electrophotographic image forming apparatus, the process cartridge includes an electrophotographic photosensitive member; a developing member for developing an electrostatic latent image forming on the electrophotographic photosensitive member; a developing device frame including a first frame portion supporting the developing member and a second frame portion having a developer accommodating portion for accommodating a developer to be used for developing the electrostatic latent image by the developing member; first and second electroconductive portions disposed spaced from each other to detect, by the main assembly of the apparatus, a remaining amount of the developer in the process cartridge; a cartridge contact electrically connectable with the main assembly of apparatus when the process cartridge is mounted to the main assembly of the apparatus, the cartridge contact being disposed in the second frame portion; a contacting electrode electrically connected with the cartridge contact, the contacting electrode being disposed in the second frame portion; a first electroconductive portion contact electrically connected with the first electroconductive portion, the first electroconductive portion contact being disposed in the first frame portion, and the first electroconductive portion contact and the contacting electrode are contacted to each other at a connecting portion between the first frame portion and the second frame portion.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is a schematic illustration of an electrophotographic image forming apparatus according to an embodiment of the present invention.

FIG. 2 is a longitudinal sectional view of a process cartridge according to an embodiment of the present invention.

FIG. 3 is an enlarged longitudinal sectional view of a connecting portion between developing device frames according to an embodiment of the present invention.

FIG. 4 is a perspective view of a connecting portion of a developer accommodating container according to an embodiment of the present invention.

FIG. 5 is a perspective view of a connecting portion of a developer chamber according to an embodiment of the present invention.

FIG. 6 is a perspective view of an outer appearance of the process cartridge as seen from the bottom side thereof.

FIG. 7 is a perspective view of an outer appearance of a mounting portion of a main assembly of an apparatus to which the process cartridge is mounted.

FIG. 8 is a perspective view of a developer accommodating container to illustrate developer amount detecting means according to an embodiment of the present invention.

FIG. 9 is a perspective view of a developer accommodating container to illustrate developer amount detecting means according to an embodiment of the present invention.

FIG. 10 is an enlarged perspective view of the developer accommodating container and a developer accommodating container cap to illustrate connection of the developer amount detecting means according to an embodiment of the present invention.

FIG. 11 is an enlarged longitudinal sectional view of a connecting portion between the developer chamber and the developer accommodating portion according to an embodiment of the present invention.

FIG. 12 is a longitudinal sectional view of a process cartridge according to another embodiment of the present invention.

FIG. 13 is a perspective view of a connecting portion of the developer chamber according to another embodiment of the present intention.

FIG. 14 is an enlarged perspective view of the developer chamber and the developer accommodating container to illustrate a connection of developer amount detecting means according to another embodiment of the presentation.

FIG. 15 is an enlarged longitudinal sectional view of a connecting portion between the developer chamber and the developer accommodating portion according to a further embodiment of the present intention.

FIG. 16 is a perspective view of a connecting portion of the developer chamber according to a further embodiment of the present intention.

FIG. 17 is an enlarged perspective view of the developer chamber and the developer accommodating container to illustrate a connection of developer amount detecting means according to a further embodiment of the presentation.

FIG. 18 is an enlarged longitudinal sectional view of a connecting portion between the developer chamber and the developer accommodating portion according to a further embodiment of the present intention.

### PREFERRED EMBODIMENT OF THE PRESENT INVENTION

The description will be made as to the process cartridges and the electrophotographic image forming apparatus according to the embodiment of the present invention in conjunction with accompanying drawings.

Embodiment 1

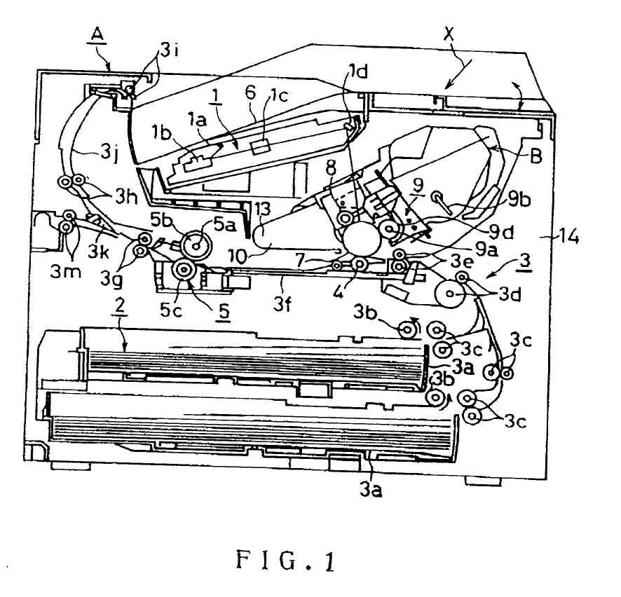

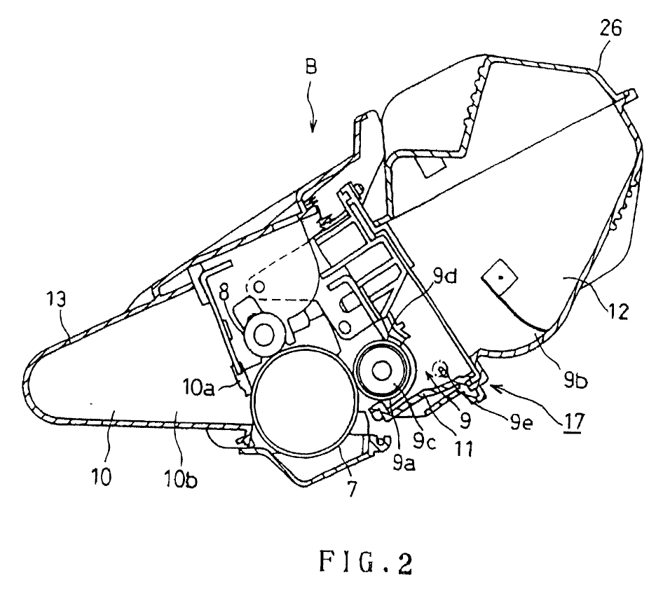

Referring to FIGS. 1 and 2, the description will first be made as to the process cartridge and the electrophotographic image forming apparatus to which the process cartridge is detachably mountable, according to Embodiment 1 of the present invention.

In this embodiment, the electrophotographic image forming apparatus is a laser beam printer A which forms and image on the recording material through an electrophotographic image forming process. FIG. 1 is a schematic exceptional view of the laser beam printer A. FIG. 2 is a substantial longitudinal section of the process cartridge B according to this embodiment of the present invention.

The laser beam printer A comprises an electrophotographic photosensitive member in the form of a drum, namely, a photosensitive drum 7. On the surface of the photosensitive drum 7, an electrostatic latent image is formed by electrostatic latent image forming means. More particularly, the surface of the photosensitive drum 7 is electrically charged by a charge member in the form of a charging roller 8 and is exposed to laser beam in accordance with image information from a laser diode 1a through a polygonal mirror 1b lens 1c and reflection mirror 1d constituting exposure means, so that latent image is formed in accordance with that image information on the photosensitive drum 7. The electrostatic latent image is developed by developing means 9 into a toner image. In this embodiment, the developing means 9 includes a developing member in the form of a developing roller 9a and a developing blade 9d for regulating a layer thickness of the developer carried on the developing roller 9a. Adjacent to the developer chamber 11, there is provided a developer accommodating container 12 functioning as a developer accommodating portion. The developer is fed out of the developer accommodating container 12 to the developing roller 9a in the developer chamber the rotation of the developer feeding member 9b. In the developer chamber 11, there is provided a developer stirring member 9C adjacent to the developing roller 9a to circulate the developer in the developer chamber 11. The developing roller 9a contains a fixed magnet 9c therein. By the rotation of the developing roller 9a, the developer is fed. With the feeding, the developer is electrically charged by friction with the developing blade 9d (triboelectric charge), and simultaneously formed into a developer layer having a predetermined thickness. The developer is supplied to the developing zone of the photosensitive drum 7. The developer thus supplied to the developing zone is transferred to the latent image on the photosensitive drum 7 to form a toner image. The developing roller 9a is connected with a developing bias circuit and is normally supplied with a developing bias voltage which is in the form of an AC biased DC voltage. In this embodiment, the developer is a magnetic developer.

On the other hand, a recording material (paper, OHP sheet or the like) accommodated in the sheet feeding cassette 3a is fed out to the transfer position in synchronism with formation of the toner image by a pick-up roller 3b through a pair of feeding rollers 3c, 3d and a pair of registration rollers 3C. At the transfer position, that is provided a transferring means in the form of a transfer roller 4, and the toner image is transferred from the surface of the photosensitive drum 7 onto the recording material 2 by application of the voltage to the transfer roller 4.

The recording material 2 now having the toner image transferred thereonto is fed to fixing means 5 along a feeding guide 3f. The fixing means 5 is provided with a driving roller 5c and a fixing roller 5b contained a heater 5a therein it fixes the toner image on the recording material 2 by application of heat and pressure on the recording material 2 pressing therethrough.

The recording material 2 is further fed by discharging rollers 3g, 3h, 3l onto a discharging tray 6 through a reverse path 3J. The discharging tray 6 is provided at the top portion of the main assembly 14 of the laser beam printer A. A swingable flapper 3K is operable to discharge the recording material 2 not through the discrimination path 33 but by the pair of discharging rollers 3m. In this embodiment, the feeding means is constituted by the pick-up roller 3b, the pair of feeding rollers 3c, 3d, the pair of registration rollers 3C, the feeding guide 3f, the pair of discharging roller 3g, 3h, 3l and the pair of discharging rollers 3m.

The photosensitive drum 7, after the toner image is transferred onto the recording material 2 by the transfer roller 4, is cleaned by cleaning means 10 so that residual toner remaining on the photosensitive drum 7 is removed. Thereafter, the photosensitive drum 7 is prepared for the next image forming process. The cleaning means 10 comprises an elastic cleaning blade (cleaning member) 10a press-contacted to the photosensitive drum 7 which functions to scrape the residual developer off the photosensitive drum 7 into a residual developer container 10b.

In this embodiment, as shown in FIG. 2, the process cartridge B has the following constructions. It comprises a developer chamber (first frame portion) 11, a developer accommodating container (second frame portion) 12, a developer accommodating container cap (cap) (third frame portion) 26, which are welded into an integral part. In the developer accommodating container 12, there is provided a developer feeding member 9b. The developer chamber 11 is provided with developing means including a developing roller 9a and a developing blade 9d. With the developing device frame 17, a cleaning frame 13 provided with a photosensitive drum 7, cleaning means 10 and a charging roller 8 is coupled and by which a process cartridge is constituted.

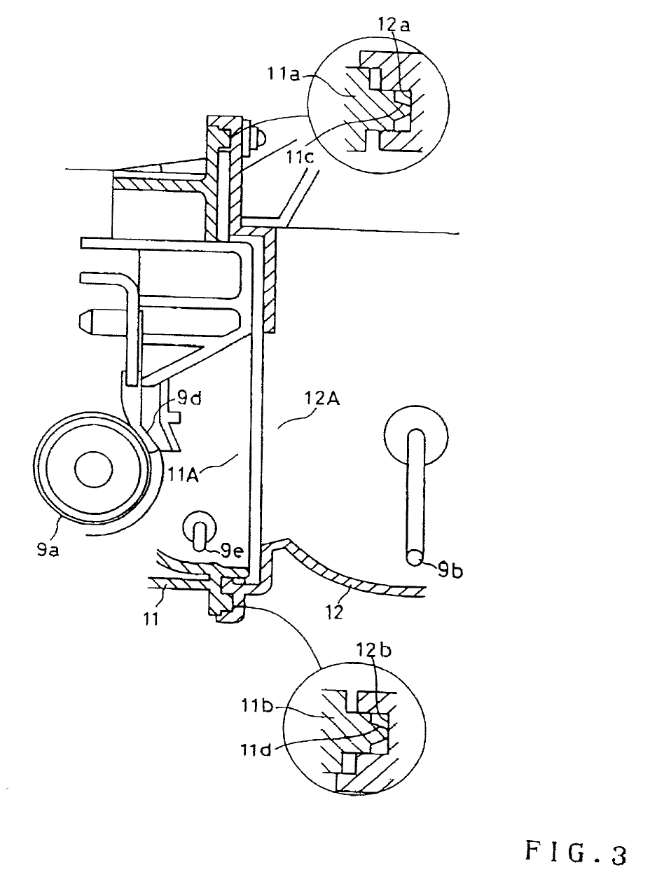

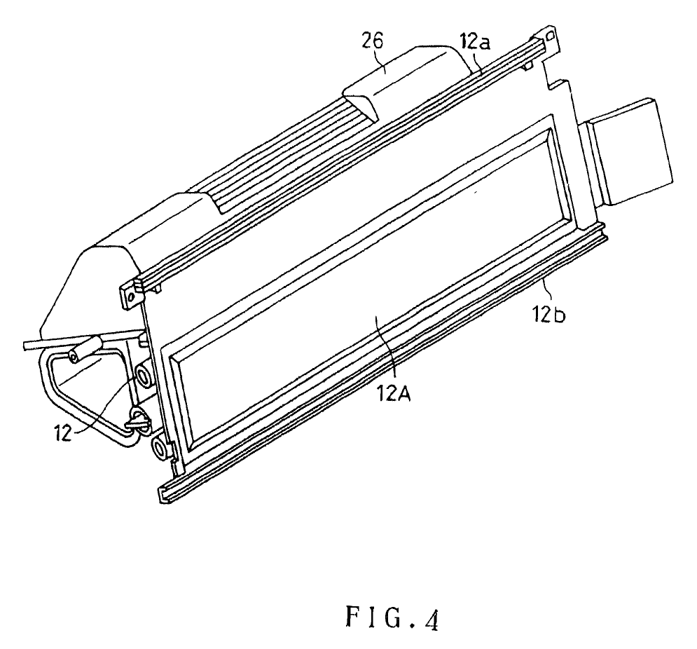

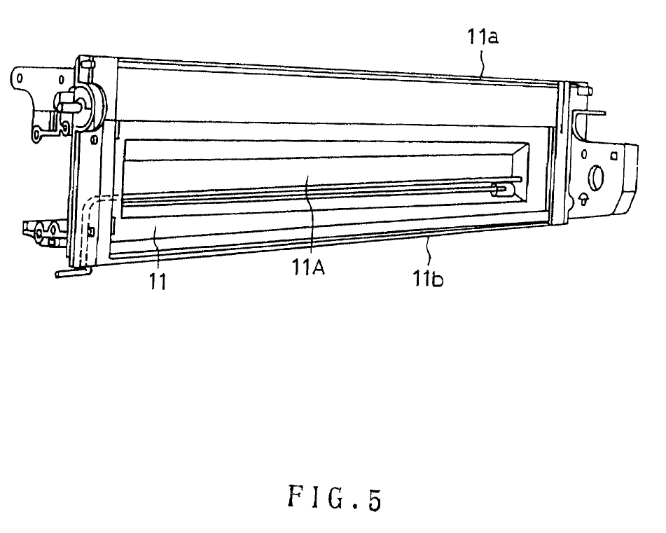

As shown in FIGS. 3, 4 and 5 and a connection surface of the developer accommodating container 12 relative to the developer chamber 11 is provided with grooves 12a, 12b extended in the longitudinal direction at the upper portion and the lower portion of the opening 12A of the developer accommodating container 12 as shown in FIG. 3. The connection surface of the developer chamber 11 relative to the developer accommodating container 12 is provided with projections 11a, 11b for engagement with the grooves 12a, 12b. The top surfaces of the projections 11a, 11b are provided with triangular ribs 11c, 11d for ultrasonic welding. The recesses 12a and 12b and projections 11a, 11b constitute a welding portion between the developer accommodating portion 12 and the developer chamber 11. When the developer accommodating container 12 and the developer chamber 11 are welded with each other, the grooves 12a, 12b of the developer accommodating container 12 and the projections 11a, 11b of the developer chamber 11 are engaged with each other after they are provided with respective parts, and the developer chamber 11 and the developer accommodating container 12 are press-contacted to each other. Then, ultrasonic vibration is imparted between the grooves 12a, 12b and the projections 11a, 11b. By doing so, the triangle ribs 11c, 11d are welded with the grooves 12a, 12b due to the resulting frictional heat, and therefore, developer accommodating container 12 and the developer chamber 11 are fastened to each other.

At the connecting portion between the developer accommodating container 12 and the cap 26, a triangle rib is provided at the cap 26 side. Similarly, the ultrasonic welding is effected using the triangle rib and the connection surface of the developer accommodating container 12.

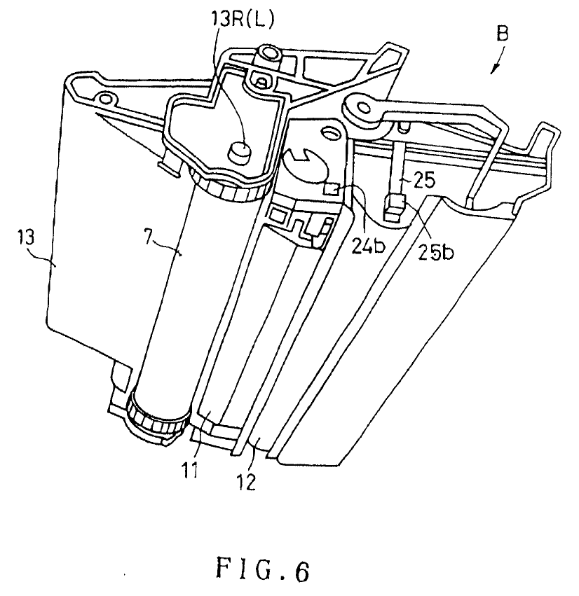

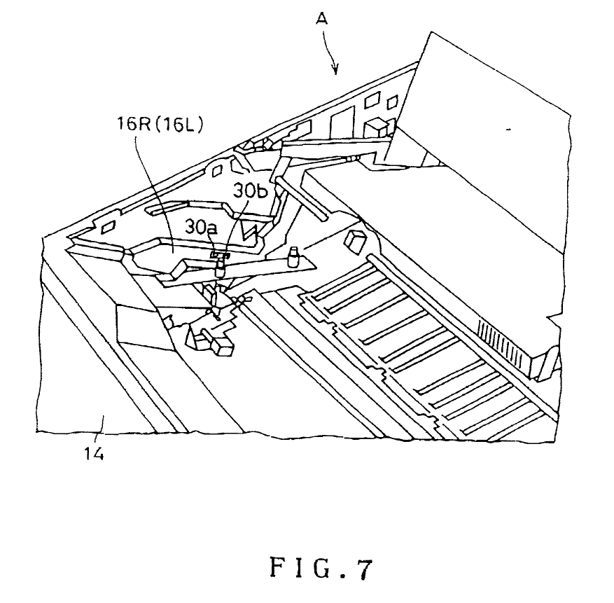

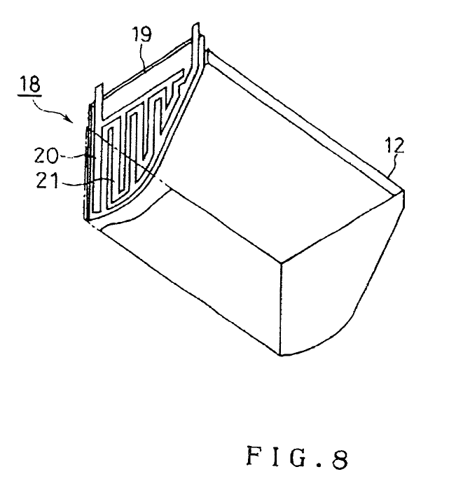

The process cartridge B is detachably mountable to a cartridge mounting means provided in the main assembly 14 of the image forming apparatus by the user. According to this embodiment, the cartridge mounting means comprises a guide means 13R (13L) (FIG. 6) formed on the outer surface at both sides of the process cartridge B and a guide portion 16R (16L) formed in the main assembly 14 of the apparatus and engageable with the guide means 13R (13L) (FIG. 7). In this embodiment, the process cartridge B is provided with a developer amount detecting means which is capable of detecting substantially real-time a remaining amount in the developer accommodating container 12 as the developer is consumed from the developer accommodating container 12. FIG. 8 shows the developer amount detecting means used in this embodiment. In this embodiment, the developer amount detecting means has a detection electrode 18 disposed at a position contactable to the developer such as an inner surface or an inner bottom surface of the developer accommodating container 12 such that contact area relative to the developer changes with decrease of the developer.

The detection electrode 18 comprises a pair of electroconductive portions, namely, a first electroconductive portion 20 and a second electroconductive portion 21 which are arranged on a substrate 19 at predetermined intervals. The two electroconductive portions 20, 21 are in the form of a number of interlaced combs. The detection electrode 18 detects the electrostatic capacity between the first and second electroconductive portions 20, 21 which constitute a pair of parallel electrodes, by which it detects the amount of the developer in the developer accommodating container 12.

The developer has a larger dielectric constant than the air. Therefore, by the contact of the developer to the surface of the detection electrode 18, the electrostatic capacity between the electroconductive portions 20, 21 increases. Therefore, by the use of the detection electrode 18, a predetermined calibration curve is used to determine the amount of the developer from the area of the developer contacted to the surface of the detection electrode 18. By doing so, the developer amount in the developer accommodating container 12 can be detected irrespective of the cross-sectional configuration of the developer accommodating container 12 or the configuration of the detection electrode 18. In this embodiment, the first electroconductive portion 20 is an output side electrode of the detection electrode, and the second electroconductive portion 21 is an input side electrode of the detection electrode. However, this is not limiting. The process cartridge B of this embodiment is provided with a connection electrode for the detection electrode 18. More particularly, the process cartridge B is provided with a first contacting electrode (output contact electrode) 24 for supplying the electric signal from the detection electrode 18 to the main assembly of the apparatus and a second contacting electrode (input contact electrode) 25 for receiving from the main assembly 14 of the apparatus an input voltage for the detection electrode 18.

The process cartridge B has a cartridge side contact (cartridge contact) contactable with the main assembly 14 of the apparatus. In this embodiment, as shown in FIG. 6, a first cartridge contact (output contact) 24b is provided at one of the ends of the first contacting electrode 24 at one longitudinal end of the process cartridge B, and a second cartridge contact (input contact) 25b is provided at one of the ends of the second contacting electrode 25.

The first cartridge contact 24b and the second cartridge contact 25b is electrically connected with a main assembly side contact (main assembly cartridge contact) provided in the main assembly of apparatus, when the process cartridge is mounted to the main assembly 14 of apparatus. As shown in FIG. 7, the main assembly 14 of apparatus is provided with a main assembly input contact (second main assembly cartridge contact) 30a and a main assembly output contact (first main assembly cartridge contact) 30b.

The main assembly side contacts 30a, 30b are electrically connectable with the first cartridge contact 24a and the second cartridge contact 25b. Through the respective contacts, the voltage is applied to the second electroconductive portion 21 of the detection electrode 18, and the detection signal is outputted from the first electroconductive portion 20. In the main assembly 14 of apparatus, the remaining amount of the developer is displayed substantially real-time in accordance with the signal on a display screen of the main assembly 14 or an external equipment such as a computer connected for communication with the main assembly 14 of the apparatus.

In this embodiment, the first cartridge contact 24b is provided on the outer surface of the developer chamber (first frame portion) 11. The second cartridge contact 25b is mounted on the outer surface of the developer accommodating container (second frame portion) 12. Therefore, the first electroconductive portion (output side electrode) 20 of the detection electrode 18 has to be connected from the developer accommodating container 12 through the developer container 12.

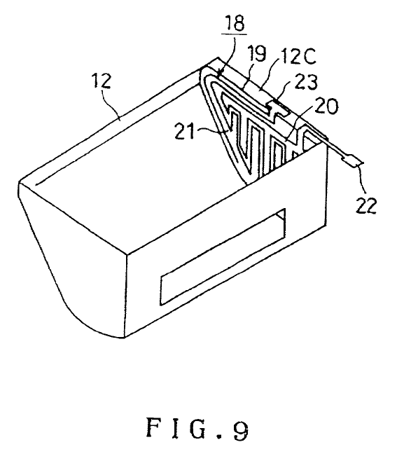

Referring to FIGS. 9 through 11, the description will be made as to the electrical connection of the detection electrode 18. In this embodiment, as shown in FIG. 9, from the substrate 19 on which the detection electrode 18 is provided, a first electroconductive portion contact 22 electrically connected with the first electroconductive portion 20 of the detection electrode 18 and a second electroconductive portion contact 23 electrically connected with the second electroconductive portion 21 are projected out. In this embodiment, the first electroconductive portion contact 22 and the second electroconductive portion contact 23 are integral with the first electroconductive portion 20 and the second electroconductive portion 21, respectively.

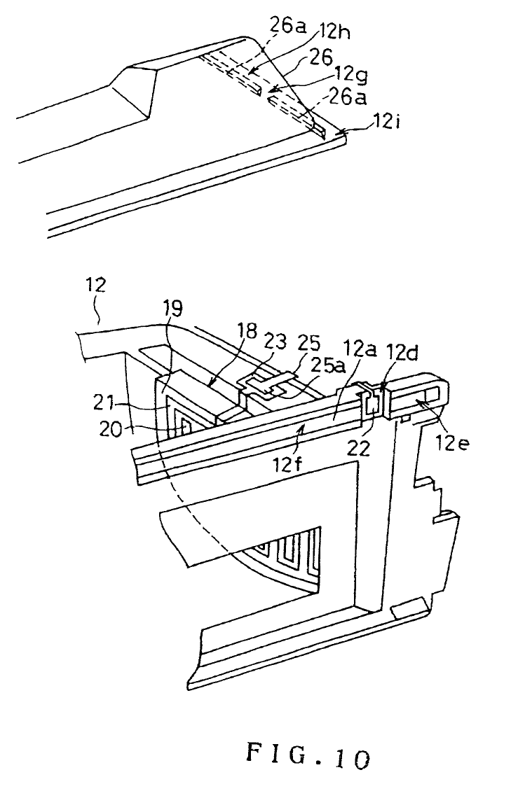

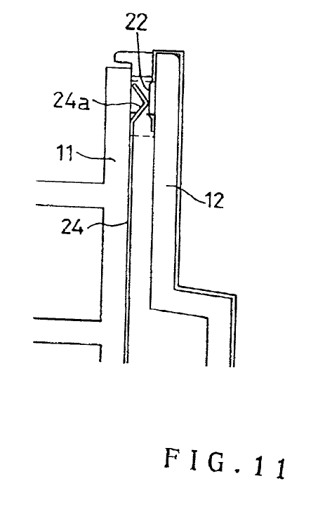

The description will be made as to the connecting portion of the first electroconductive portion contact 22 of the detection electrode 18. As shown in FIGS. 10 and 11, the first electroconductive portion contact 22 is contacted to and therefore is electrically connected with the first contacting electrode 24 at the connecting portion between the developer chamber 11 and the developer accommodating container 12. At one end of the first contacting electrode 24, a contact portion 24a is provided and is contacted into the first electroconductive portion contact 22.

Here, as described hereinbefore, the developer accommodating container 12 is provided with a groove 12a for welding between the developer accommodating container 12 and the developer chamber 11. The first electroconductive portion contact 22 is at such a position as corresponds to the groove 12a partly cut away. The contact portion 24a is disposed at such a position that projection 11a having the triangle rib 11c (welding portion of the developer chamber) is partly cut away.

Thus, the welding portion between the developer accommodating container 12 and the developer chamber 11 has a first welded portion 12e and a second welded portion 12f which are disposed spaced in the longitudinal direction of the developer accommodating container 12. The contact portion between the first electroconductive portion contact 22 and the output contact 24a is disposed in the space portion 12d therebetween.

As shown in FIG. 11, when the developer chamber 11 and the developer accommodating container 12 are fastened with each other by ultrasonic welding, the contact portion 24 a and the first electroconductive portion contact 22 are press-contacted to each other, between the developer accommodating container 12 and the developer chamber 11, by which electrical connection is established therebetween.

In this embodiment, the first contacting electrode 24 is thin. The contact portion 24a is deformed into a height of the triangle rib 11c provided that top surface of the projection 11a or a little bit higher than that toward the developer accommodating container 12. The deformed contact portion 24a is sandwiched between the developer chamber 11 and the developer accommodating container when the projection 11a and the groove 12a are connected with each other by the ultrasonic welding. By doing so, the contact portion 24a is assuredly press-contacted to the first electroconductive portion contact 22.

In this manner, the first electroconductive portion contact 22 and the contact portion 24a are sandwiched and contacted at the space portion 12d in the continuous welded portions 12C, 12f between the developer accommodating container 12 and the developer chamber 11 By doing so, the two electrodes are shortly contacted to each other, so that conduction defect duty shortage of contact pressure can be avoided.

The description will be made as to the connecting portion of the second electroconductive portion contact 23. As shown in FIG. 10, the second electroconductive portion contact 23 is contacted to an electrically connected with the second contacting electrode 25 at the connecting portion between the developer accommodating container 12 and the cap 26. At one end of the second contacting electrode 25, a contact portion 25a is provided and is contacted into the first electroconductive portion contact 23.

Here, a surface of the cap 26 is provided with the triangle rib 26a at the welded portion relative to the developer accommodating container 12, as described hereinbefore. However, there is no triangle rib 26a at the portion where the second electroconductive portion contact 23 is contacted to the contact portion 25a. By doing so, the welding portion between the developer accommodating container 12 and the cap 26, comprises a first welded portion 12h and a second welded portion 12l which are disposed spaced from each other in a direction perpendicular to the longitudinal direction of the developer accommodating portion 12. The space portion 1g is the contact portion between the second electroconductive portion contact 23 and the contact portion 25a.

When the developer accommodating container 12 and the cap 26 are welded with each other, the second electroconductive portion contact 23 and the contact portion 25a are sandwiched and a press-contacted between the developer accommodating container 12 and the cap 26.

In this manner, the second electroconductive portion contact 23 and the contact portion 25a of the first contacting electrode are sandwiched and contacted at the welded portions 12h, 12l between the developer accommodating container 12 and the cap 26. By doing so, the two electrodes are shortly contacted to each other, so that conduction defect duty shortage of contact pressure can be avoided.

Thus, according to this embodiment, the electric connection within the process cartridge is assured. Therefore, the voltage receivable and a process cartridge from the main assembly of apparatus can be assuredly supplied to the predetermined member. Thus, the electric wiring can be assured across the frames.

Embodiment 2

The description will be made as to a second Embodiment. The fundamental structure of the image forming apparatus of this embodiment is the same as that of Embodiment 1, except the developer amount detecting means and the connecting structures. Therefore, the same reference numerals are assigned to the corresponding elements.

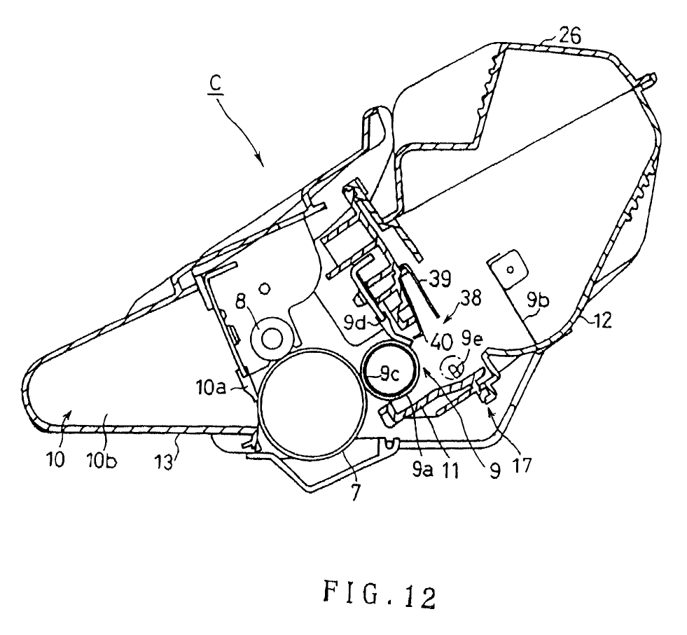

FIG. 12 is a schematic longitudinal sectional view of the process cartridge C according to this embodiment. The structural frames of the process cartridge are the same us with Embodiment 1. It comprises a developer chamber (first frame portion) 11, a developer accommodating container (second frame portion) 12, a developer accommodating container cap (cap) (third frame portion) 26, which are welded into an integral part. In the developer accommodating container 12, there is provided a developer feeding member 9b. The developer chamber 11 is provided with developing means including a developing roller 9a and a developing blade 9d. With the developing device frame 17, a cleaning frame 13 provided with a photosensitive drum 7, cleaning means 10 and a charging roller 8 is coupled and by which a process cartridge is constituted.

The developing device frame 17 of the process cartridge C is welded by ultrasonic welding in the same manner as with Embodiment 1. More particularly, the developer chamber 11 is provided with a projection 11a (11b) having a triangle rib 11c (11d) The developer accommodating container 12 is provided with a groove 12a (12b) The cap 26 is provided with a triangle rib 26a.

In this embodiment, the process cartridge C is provided with a developer amount detecting means which is capable of detecting substantially real-time a remaining amount in the developer accommodating container 12 as the developer is consumed from the developer accommodating container 12.

In this embodiment, as shown in FIG. 12, the developer amount detecting means comprises a first first electroconductive portion 39 and a second electroconductive portion 40 in the form of plates as a detection electrode constituting a developer detection portion 38. The first and second electroconductive portions 39, 40 are arranged along the length of the developing roller 9a. A voltage is applied to one of first electroconductive portion 39 and the second electroconductive portion 40, so that electrostatic capacity is induced between the electroconductive portions 39, 40. The amount of the developer is detected by detecting the electrostatic capacity.

In this embodiment, the voltage is applied to the first electroconductive portion 39. Thus, first electroconductive portion 39 is an input electrode of the detection electrode, and the second electroconductive portion 40 is an output electrode thereof. However, this is not limiting.

A magnetic developer used in this embodiment is attracted to the surface of the developing roller the magnetic force provided by the fixed magnet 9c in the developing roller 9a. The developer is scraped off the developing roller the developing blade 9d during rotation of the developing roller 9a and is made uniform on the surface of the developer roller 9a.

The first and second electroconductive portions 39, 40 are disposed such that developer removed from the surface of the developing roller 9a enters between the electroconductive portions 39, 40.

Since the dielectric constant of the developer is higher than that of the air, the electrostatic capacity is larger when the developer exists between the first and the second electroconductive portions 39, 40. When the amount is large in the developer chamber 11, the removed developer sequentially enters between the first and second electroconductive portions 39, 40. Therefore, the outputted electrostatic capacity is always large. With the consumption of the developer from the developer chamber 11, the amount of the developer entering between the first and second electroconductive portions 39, 40 decreases. Correspondingly, the electrostatic capacity decreases, too. Thus, the developer amount detecting means detects substantially real time the amount of the developer by detecting the electrostatic capacity.

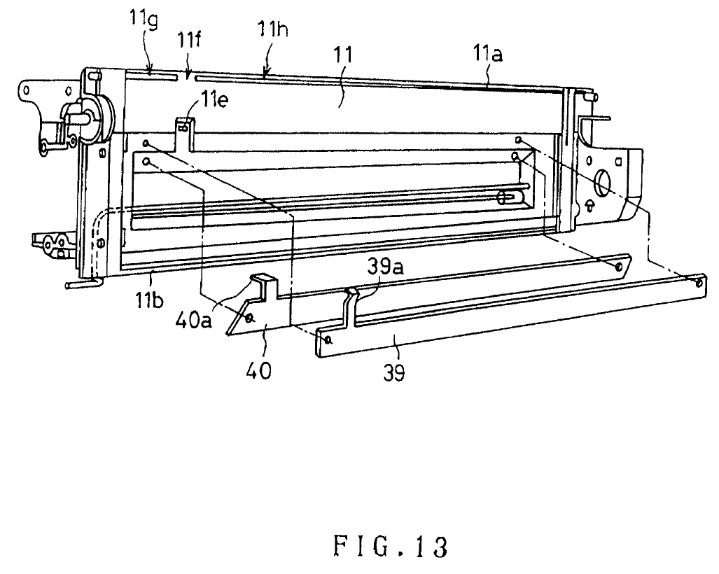

Referring to FIGS. 13 through l5 the description will be made as to the connecting manner of the developer amount detecting means.

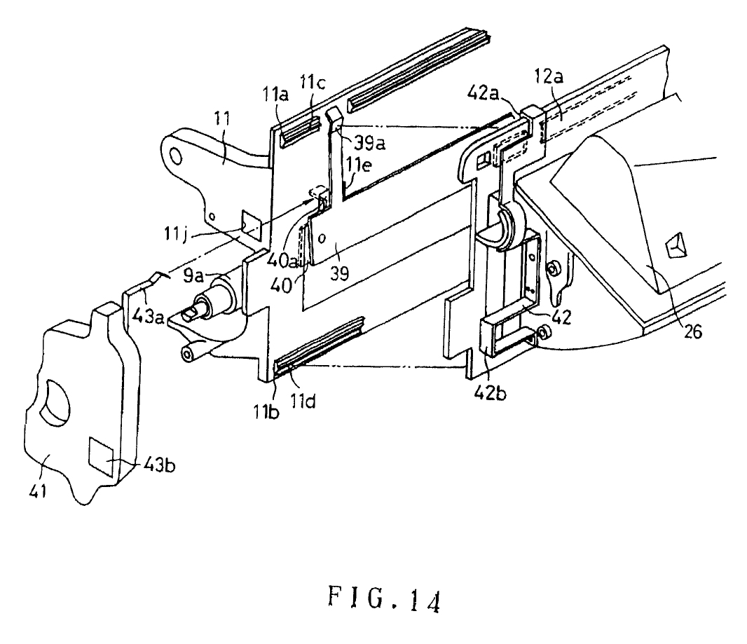

As shown in FIGS. 13 through 14, the first electroconductive portion 39 and the second electroconductive portion 40 are mounted to the developer chamber 11.

The first electroconductive portion 39 has an integral first electroconductive portion contact 39a extending in the direction perpendicular to the longitudinal direction thereof. A free end of the first electroconductive portion contact 39a is disposed so as to correspond to a partly cutaway portion of a projection 11a (welded rib) provided in the developer chamber 11 when the first electroconductive portion 39 is mounted to the developer chamber 11. In this embodiment, the free end portion of the first electroconductive portion contact 39a provided in the first electroconductive portion 39 is deformed into a projection extending into connecting direction relative to the developer accommodating container 12 so as to have substantially the same height as the triangle rib 11c provided on the top surface of the projection 11a or a little bit higher than that.

The developer accommodating container 12 to be welded with the developer chamber 11, as shown in FIGS. 14, is provided with a first contacting electrode (input contact electrode) 42 as a connection electrode for the detection electrode. Most of the part of the first contacting electrode 42 is provided outside the developer accommodating container 12. At one end of the first contacting electrode 42, there is provided a one of the contact portions (folded-back portion) 42a of the first contacting electrode 42. The folded back portion 42a is disposed at the connecting portion between the developer accommodating container 12 and the developer chamber 11. The folded back portion 42a is disposed such as to correspond to the partly cut-away portion of the upper groove 12a of the developer accommodating container 12 in the Figure. In this manner, the folded back portion 42a (one of the contact portions of the first contacting electrode 42) is exposed to the welding portions side relative to the developer chamber 11.

The welding portion between the developer accommodating container 12 developer chamber 11 comprises a first welded portion 11g and a second welded portion 11h which are disposed spaced from each other in the longitudinal direction. The contact portion between the projection 39a and the folded back portion 42a is disposed corresponding to the clearance portion 11f.

The folded back portion 42a is contacted to an electrically connected with the first electroconductive portion contact 39a mounted an the developer chamber 11.

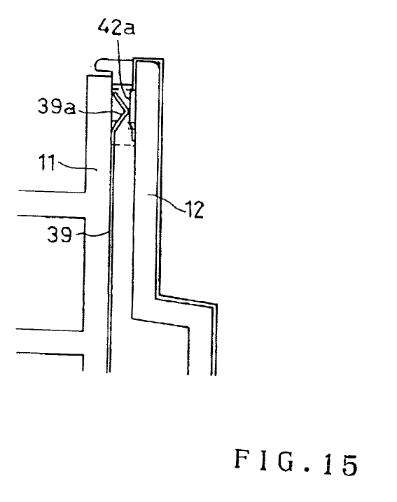

As shown in FIG. 15, the free end of the first electroconductive portion contact 39a (projection) is sandwiched between the developer chamber 11 and the developer accommodating container 12 when the developer chamber 11 and the developer accommodating container 12 are fastened by ultrasonic welding. By doing so, the first electroconductive portion contact 39a is assuredly press-contacted to the folded back portion 42a provided in the developer accommodating container 12.

One longitudinal end surface of the process cartridge is provided with a cartridge side contact (cartridge contact) which is contactable to a contact provided in the main assembly of apparatus. More particularly, one of the ends of the first contacting electrode 42 has a first cartridge contact (input contact) 42b. The cartridge side input contact 42b is electrically contactable to the main assembly side contact (main assembly cartridge contact) when the process cartridge C is mounted to the main assembly 14 of apparatus. In this embodiment, the first cartridge contact 42b is electrically contactable to the main assembly input contact (first main assembly cartridge contact) 30a provided in the main assembly 14 of apparatus.

A voltage (bias) is applied to the first electroconductive portion 39 through the first contacting electrode 42 from the contact 30a (FIG. 7) provided in the main assembly 14 of the apparatus.

On the other hand, the second electroconductive portion 40 is provided with an integral second electroconductive portion contact 40a. The second electroconductive portion contact 40a extends to project out of the surface of the plate of the second electroconductive portion 40 and is bent When the second electroconductive portion 40 is mounted to the developer chamber 11, the second electroconductive portion contact 40a is inserted through a through-opening 11e formed in the developer chamber 11. By doing so, the second electroconductive portion contact 40a is projected through the through hole 11e.

One longitudinal end of surface of the process cartridge (end portion of the developer chamber 11) is provided with an end cover 41 fixed thereto, the end cover 41 functioning to rotatablely support the developing roller way of a bearing. The end cover 41 is provided with a second contacting electrode (output contact electrode) 43 (connection electrode) fixed thereto. A contact portion 43a formed at one of the ends of the second contacting electrode 43 provided on the end cover 41, electrically connected with the second electroconductive portion contact 40a through the opening 118 when the end cover 41 is mounted to the side of the developer chamber 11.

The end cover 41 is provided with a second cartridge contact (output contact) 43 at the other end of the second contacting electrode 43 The second cartridge contact 43b is fixed on the outer surface of the end cover 41 and is exposed to outside. The contact portion 43b is electrically connected to the main assembly output contact (second main assembly cartridge contact) 30b (FIG. 7) provided in the main assembly 14 of the apparatus when the process cartridge C is mounted to the main assembly 14 of apparatus.

In this embodiment, a signal corresponding to the electrostatic capacity between the first and second electroconductive portions 39, 40 is outputted to the main assembly 14 of apparatus through the second contacting electrode 43.

In the main assembly 14 of apparatus, the remaining amount of the developer is displayed substantially real-time in accordance with the signal on a display screen of the main assembly 14 or an external equipment such as a computer connected for communication with the main assembly 14 of the apparatus.

According to this embodiment, the first contacting electrode 42 and the first electroconductive portion 39 are sandwiched and contacted to each other at the space portion 11f of the continuous welding portions 11g and 11h between the developer accommodating container 12 and the developer chamber 11. By doing so, are as shortly contacted between the developer chamber 11 and the developer accommodating container 12 so as to avoid improper contact or the like.

Thus, according to this embodiment, the electric connection within the process cartridge is assured. Therefore, the voltage receivable and a process cartridge from the main assembly of apparatus can be assuredly supplied to the predetermined member. Thus, the electric wiring can be assured across the frames.

Embodiment 3

The description will be made as to a third embodiment. The fundamental structures of the image forming apparatus and the process cartridge are the same as with Embodiment 2. This embodiment is different therefrom only in the connection of the developer amount detecting means. Therefore, the detailed description is committed by assigning the same reference numerals to the elements having the corresponding functions.

The structure of the frames of the process cartridge is the same as with Embodiment 2. In this embodiment, the frames are welded by ultrasonic welding.

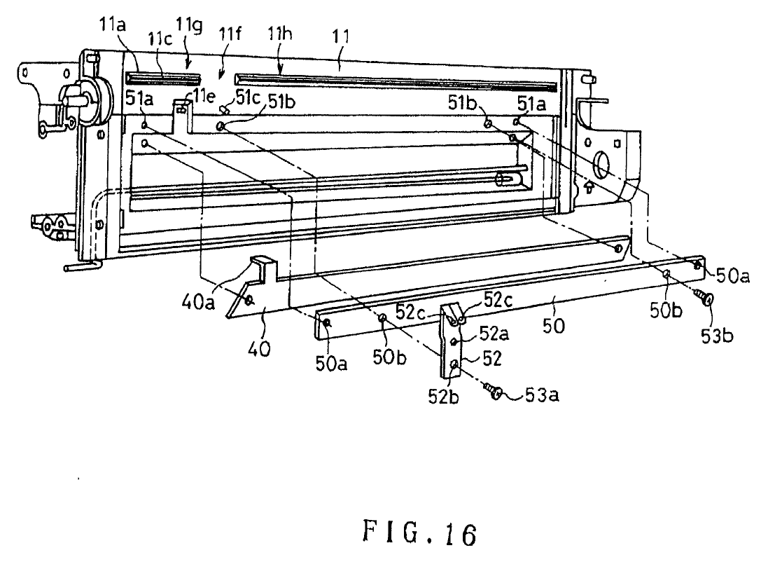

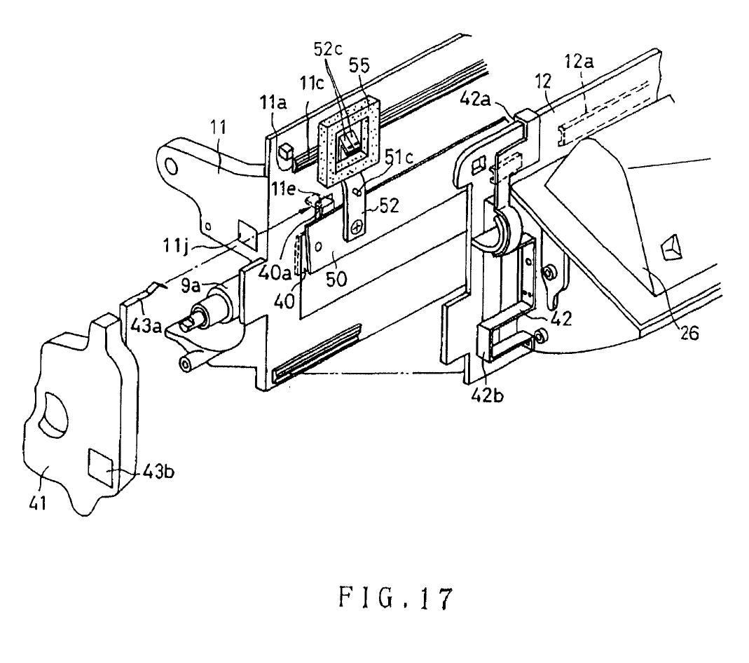

The process cartridge of this embodiment is provided with a plate-like first electroconductive portion 50 and second electroconductive portion 40 as developer amount detecting means. As shown in FIGS. 16 and 17, the first electroconductive portion 50 and the second electroconductive portion 40 are mounted to the developer chamber 11. In this embodiment, too, the first electroconductive portion 50 is an input side electrode of the detection electrode, and the second electroconductive portion 40 is an output side electrode of the detection electrode. The detection principle for the amount of the developer by the developer amount detecting means is the same house with Embodiment 2.

The description will be made as to the connection of the developer amount detecting means. The first electroconductive portion 50 is correctly positioned by engagement between positioning holes 50a provided at both of the longitudinal ends and positioning bosses 51a, 51a of the positioning.

They are fastened by threading screws 53a, 53b into screw bores 51b, 51b of the developer chamber (first frame portion) through holes 50b, 50b.

When the first electroconductive portion 50 is fastened to the developer chamber 11, one (screw 53a (left side in FIG. 16)) of the screws also fastens the electrode plate 52 which functions as the first electroconductive portion contact.

The electrode plate 52 functions to electrically connect between the first electroconductive portion 50 and the first contacting electrode (input contact electrode) 42 mounted to the developer accommodating container 12. The electrode plate 52 is correctly positioned by engagement between the positioning hole 52a and the positioning boss 51c of the developer chamber 11. Thereafter, by threading the small screw 53a into the hole 52b, it is fastened and is simultaneously eclectically connected with the first electroconductive portion.

A free end of the electrode plate 52 is folded back. In this embodiment, the free end is bifurcated. Each of the bifurcated end is provided with a contact portion 52c having an emboss (projection) which functions as a contact with the first contacting electrode 42. In this embodiment, the first electroconductive portion 50 and the second electroconductive portion 40 are made of non-magnetic SUS material steel so as to avoid influence against circulation of the developer in the developer chamber 11. The electrode plate 52 is disposed at a position away from the developer chamber 11, where the developer does not circulate, and is made of phosphor bronze which is proper for electrical connection.

The contact portion 52c is disposed corresponding to a cutaway portion of the projection 11a (welded rib) having the triangle rib 11c provided in the developer chamber 51.

To the developer accommodating container (second frame portion) 12, as shown in FIG. 17, the first contacting electrode 42 as the connection electrode for the detection electrode is mounted.

The structure of the contacting electrode 42 is similar to embodiment. Most of the part of the first contacting electrode 42 is outside the developer accommodating container 12. At one end of the first contacting electrode 42, there is provided a one of the contact portions (folded-back portion) 42a of the first contacting electrode 42. The folded back portion 42a is disposed at the connecting portion between the developer accommodating container 12 and the developer chamber 11. The folded back portion 42a is disposed such as to correspond to the partly cutaway portion of the upper groove 12a of the developer accommodating container 12 in the Figure. In this manner, the folded back portion 42a (one of the contact portions of the first contacting electrode 42) is exposed to the welding portions side relative to the developer chamber 11.

The welding portion between the developer accommodating container 12 developer chamber 11 comprises a first welded portion 11g and a second welded portion 11h which are disposed spaced from each other in the longitudinal direction. The contact portion between the projection 39a and the folded back portion 42a is disposed corresponding to the clearance portion 11f.

In this embodiment, the first electroconductive portion 50 and the electrode plate 52 are mounted to the developer chamber 11, and thereafter, the seal member 55 is mounted so as to enclose the contact portion 52c of the electrode plate 52. The seal member 55 functions to prevent developer leakage through the cutaway portion of the welded rib 11a. In this embodiment, the seal member 55 is made of sponge-like material having an elasticity.

The developer chamber 11 and the developer accommodating container 12 which are provided with the various parts are welded together. By doing so, the contact portion 52c of the electrode plate (first electroconductive portion contact) mounted to the developer chamber 11 and the folded back portion 42a of the first contacting electrode 42 mounted to the developer accommodating container 12 are contacted to each other so that electric connection is established between the first electroconductive portion 50 and a first contacting electrode 54.

When the developer chamber (first frame) 11 and the developer accommodating container (second frame) 12 are fastened, a projection (unshown) provided in the developer accommodating container 12 is abutted to the developer chamber 11. By doing so, a predetermined gap is maintained between the first frame 11 and the second frame 12.

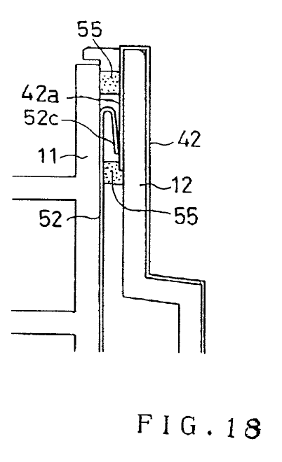

FIG. 18 shows a section of a contact portion between the electrode plate 52 and the contact portion (folded back portion) 42a of the first contacting electrode 42. The contact portion 52c of the electrode plate 52 and the folded back portion 42a of the first contacting electrode 42 are sandwiched between the developer chamber 11 and the developer accommodating container 12 when the developer chamber 11 and the developer accommodating container 12 are welded to each other. By doing so, the contact portion 52c and the folded back portion 42a are press-contacted to each other with certainty.

In this manner, according to this embodiment, the first contacting electrode 42 and the electrode 52 connected to the first electroconductive portion 50 are sandwiched and contacted to each other between the developer accommodating container 12 and the developer chamber 11 at the space or cutaway portions 11f of the continuous welded portions 11g, 11h. By doing so, are as shortly contacted between the developer chamber 11 and the developer accommodating container 12 so as to avoid improper contact or the like.

The structure of the first cartridge contact (input contact) 42b provided integrally and the other end of the first contacting electrode 42 and the structure of connecting the first cartridge contact 42b to the main assembly output contact (first main assembly cartridge contact) 30a, are similar to those of Embodiment 2.

The structure of wiring from the second electroconductive portion 40 and the second electroconductive portion 40 to the second contacting electrode (output contact electrode) is the same as with Embodiment 2. The structure of the second cartridge contact (output contact) 43b provided in the end cover 41 and the structure of connecting the second cartridge contact 43b to the main assembly output contact (second main assembly cartridge contact) 30b, are similar to those of Embodiment 2.

According to this embodiment, the electric connection in the process cartridge is assured, too. Therefore, the voltage receivable and a process cartridge from the main assembly of apparatus can be assuredly supplied to the predetermined member. By doing so, the electrical connection across the frames is assured.

In each of the embodiments, the connection between the first frame 11 and the second frame 12 are not limited to that using ultrasonic welding, but another welding, bonding material, snap fit and the like are usable.

In this invention, the frame is a frame to which the process means such as a developing roller is mounted, a developer accommodating container for accommodating the developer, or the like. The electrode (developer amount detection electrode, connection electrode) may be in the form of a leaf spring, a coil spring, a printed electroconductive material as well as a metal plate or a metal rod. The electrical connection may be established by contact of electroconductive members an integral electroconductive member.

As described in the foregoing, according to the present intention, the electrical connection in the process cartridge is assured.

While the invention has been described with reference to the structures disclosed herein, it is not confined to the details set forth and this application is intended to cover such modifications or changes as may come within the purposes of the improvements or the scope of the following claims.

What is claimed is:

1. A process cartridge detachably mountable to a main assembly of an electrophotographic image forming apparatus, said process cartridge comprising:
an electrophotographic photosensitive member;
a developing member for developing an electrostatic latent image forming on said electrophotographic photosensitive member;
a developing device frame including a first frame portion supporting said developing member and a second frame portion having a developer accommodating portion for accommodating a developer to be used for developing the electrostatic latent image by said developing member;
first and second electroconductive portions disposed spaced from each other to detect, by the main assembly of the apparatus, a remaining amount of the developer in said process cartridge;
a cartridge contact electrically connectable with the main assembly of apparatus when said process cartridge is mounted to the main assembly of the apparatus, said cartridge contact being disposed in said second frame portion;
a contacting electrode electrically connected with said cartridge contact, said contacting electrode being disposed in said second frame portion;
a first electroconductive portion contact electrically connected with said first electroconductive portion, said first electroconductive portion contact being disposed in said first frame portion, and said first electroconductive portion contact and said contacting electrode are contacted to each other at a connecting portion between said first frame portion and said second frame portion.

2. A process cartridge according to claim 1, wherein said first frame portion and said second frame portion are connected with each other by ultrasonic welding along a longitudinal direction, and wherein an ultrasonic weld portion therebetween includes a first welded portion and a second welded portion which are juxtaposed with a gap therebetween, and said first electroconductive contact and said contacting electrode are disposed in the gap.

3. A process cartridge according to claim 1 or 2, wherein said cartridge contact is an input contact for receiving from the main assembly of apparatus a bias voltage to be applied to said first electroconductive portion when said process cartridge is mounted to the main assembly of the apparatus, said process cartridge further comprising an output contact for transmitting through the main assembly of the apparatus an electric signal corresponding to an electrostatic capacity between said first electroconductive portion and said second electroconductive portion.

4. A process cartridge according to claim 3, wherein said input contact and said output contact is provided at one longitudinal end surface of said process cartridge.

5. A process cartridge according to claim 3, wherein said input contact is provided at one longitudinal end surface of said developer accommodating portion, and said output contact is exposed outside from an end cover mounted to one longitudinal end of said first frame portion.

6. A process cartridge according to claim 1, wherein said first electroconductive portion contact is a separate member from said first electroconductive portion, and said first electroconductive contact is fastened together with said first electroconductive portion to said first frame by a screw.

7. A process cartridge according to claim 6, wherein said first electroconductive portion contact is provided with a bifurcated end portion which is folded back, and an end of the folded back portion is provided with a projection which is contacted to said contacting electrode by which said first electroconductive portion contact and said contacting electrode are electrically connected to each other.

8. A process cartridge according to claim 1, wherein said first electroconductive portion and said second electroconductive portion are mounted to said first frame.

9. A process cartridge according to claim 6, 7 or 8, wherein said first electroconductive portion and said second electroconductive portion are made of stainless steel, and said first electroconductive portion contact is made of phosphor bronze.

10. A process cartridge according to claim 1, wherein said contacting electrode and said cartridge contact are provided at one and the other ends of an integral metal member.

11. A process cartridge according to claim 2, 6, 7, 8 or 10, wherein said first electroconductive portion contact is enclosed with a seal member which is sandwiched and compressed between said first frame portion and said second frame portion.

12. A process cartridge detachably mountable to a main assembly of an electrophotographic image forming apparatus, said process cartridge comprising;
an electrophotographic photosensitive drum;
a developing roller for developing an electrostatic latent image formed on said electrophotographic photosensitive member with a developer;
a developing device frame supporting said developing roller and a second frame portion having a developer accommodating portion for accommodating a developer to be used for developing said electrostatic latent image;
first and second electroconductive portions in the form of plates disposed spaced from each other to detect, by the main assembly of the apparatus, a remaining amount of the developer in said process cartridge, said first electroconductive portion and said second electroconductive portion are amounted to said first frame;
an input contact for receiving from the main assembly of the apparatus a bias voltage to be applied to said first electroconductive portion when said process cartridge is mounted to the main assembly of the apparatus;
an output contact for transmitting to the main assembly of the apparatus an electric signal corresponding to an electrostatic capacity between said first electroconductive portion and said second electroconductive portion, wherein said electrostatic capacity is provided when the bias voltage is applied to said first electroconductive portion from said input contact, wherein said input contact and said output contact are provided at one longitudinal end of said process cartridge;
a contacting electrode electrically connected with said cartridge contact, said contacting electrode being disposed in said second frame portion;
a first electroconductive portion contact electrically connected with said first electroconductive portion and disposed in said first frame portion, said first electroconductive portion contact being enclosed with an elastic seal member, wherein said elastic seal member is sandwiched and compressed between said first frame portion and said second frame portion, and said first frame portion and said second frame portion are connected to each other by ultrasonic welding along a longitudinal direction, and the ultrasonic weld portion includes a first welded portion and a second welded portion which are juxtaposed with a gap therebetween, and wherein said first electroconductive portion contact and said contacting electrode are disposed in the gap.

13. A process cartridge according to claim 12, wherein said input contact is provided at one longitudinal end surface of said developer accommodating portion, and said output contact is exposed outside from an end cover mounted to one longitudinal end of said first frame portion.

14. A process cartridge according to claim 12, wherein said first electroconductive portion contact is a separate member from said first electroconductive portion, and said first electroconductive contact is fastened together with said first electroconductive portion to said first frame by a screw.

15. A process cartridge according to claim 14, wherein said first electroconductive portion contact is provided with a bifurcated end portion which is folded back, and an end of the folded back portion is provided with a projection which is contacted to said contacting electrode by which said first electroconductive portion contact and said contacting electrode are electrically connected to each other.

16. A process cartridge according to claim 12, 13, 14 or 15, wherein said first electroconductive portion and said second electroconductive portion are made of stainless steel, and said first electroconductive portion contact is made of phosphor bronze.

17. A process cartridge according to claim 12, wherein said contacting electrode and said cartridge contact are provided at one and the other ends of an integral metal member.

18. An electrophotographic image forming apparatus for forming an image on the recording material, to which a process cartridge is detachably mountable, said apparatus comprising:
(a) a main assembly cartridge contact;
(b) mounting means for mounting a process cartridge, said process cartridge including;
an electrophotographic photosensitive member;
a developing member for developing an electrostatic latent image forming on said electrophotographic photosensitive member;
a developing device frame including a first frame portion supporting said developing member and a second frame portion having a developer accommodating portion for accommodating a developer to be used for developing the electrostatic latent image by said developing member;
first and second electroconductive portions disposed spaced from each other to detect, by the main assembly of the apparatus, a remaining amount of the developer in said process cartridge;
a cartridge contact electrically connectable with the main assembly of apparatus when said process cartridge is mounted to the main assembly of the apparatus, said cartridge contact being disposed in said second frame portion;
a contacting electrode electrically connected with said cartridge contact, said contacting electrode being disposed in said second frame portion;
a first electroconductive portion contact electrically connected with said first electroconductive portion, said first electroconductive portion contact being disposed in said first frame portion, and said first electroconductive portion contact and said contacting electrode are contacted to each other at a connecting portion between said first frame portion and said second frame portion.

19. An electrophotographic image forming apparatus for forming an image on the recording material, to which a process cartridge is detachably mountable, said apparatus comprising:
(a) a main assembly input contact;
(b) a main assembly output contact;
(c) mounting means for mounting a process cartridge, said process cartridge including;
an electrophotographic photosensitive member;
a developing roller for developing an electrostatic latent image formed on said electrophotographic photosensitive member with a developer;
a developing device frame supporting said developing roller and a second frame portion having a developer accommodating portion for accommodating a developer to be used for developing said electrostatic latent image;
first and second electroconductive portions in the form of plates disposed spaced from each other to detect, by the main assembly of the apparatus, a remaining amount of the developer in said process cartridge, said first electroconductive portion and said second electroconductive portion are mounted to said first frame;
an input contact for receiving from said main assembly input contact a bias voltage to be applied to said first electroconductive portion when said process cartridge is mounted to the main assembly of the apparatus;
an output contact for transmitting to said main assembly output contact an electric signal corresponding to an electrostatic capacity between said first electroconductive portion and said second electroconductive portion, wherein said electrostatic capacity is provided when the bias voltage is applied to said first electroconductive portion from said input contact, wherein said input contact and said output contact are provided at one longitudinal end of said process cartridge;
a contacting electrode electrically connected with said cartridge contact, said contacting electrode being disposed in said second frame portion;
a first electroconductive portion contact electrically connected with said first electroconductive portion and disposed in said first frame portion, said first electroconductive portion contact being enclosed with an elastic seal member, wherein said elastic seal member is sandwiched and compressed between said first frame portion and said second frame portion, and said first frame portion and said second frame portion are connected to each other by ultrasonic welding along a longitudinal direction, and the ultrasonic weld portion includes a first welded portion and a second welded portion which are juxtaposed with a gap therebetween, and wherein said first electroconductive portion contact and said contacting electrode are disposed in the gap.

20. A process cartridge detachably mountable to a main assembly of an electrophotographic image forming apparatus, said process cartridge comprising:
an electrophotographic photosensitive member;
a developing member for developing an electrostatic latent image forming on said electrophotographic photosensitive member;
a developing device frame including a first frame portion supporting said developing member and a second frame portion having a developer accommodating portion for accommodating a developer to be used for developing the electrostatic latent image by said developing member;
first and second electroconductive portions disposed spaced from each other to detect, by the main assembly of the apparatus, a remaining amount of the developer in said process cartridge;
a first cartridge contact, disposed in said first frame portion, for electrical connection with the main assembly of the apparatus when the process cartridge is mounted to the main assembly of the apparatus;
a first contacting electrode disposed in said first frame portion and electrically connected with said first cartridge contact;
a first electroconductive portion contact disposed in said second frame portion and electrically connected with said first electroconductive portion;
wherein said first electroconductive portion contact and said first contacting electrode are contacted to each other at a connecting portion between said first frame portion and said second frame portion.

21. A process cartridge according to claim 20, further comprising a third frame functioning as a cap for said developer accommodating portion;
a second cartridge contact, disposed in said second frame, for electrical connection with the main assembly of the apparatus when said process cartridge is mounted to the main assembly of the apparatus;
a second contacting electrode disposed in said second frame and electrically connected with said second cartridge contact;
a second electroconductive portion contact disposed in said second frame portion and electrically connected with said second electroconductive portion;
wherein said second electroconductive portion contact and said second contacting electrode are contacted to each other at a connecting portion between said second frame portion and said third frame portion.

22. A process cartridge according to claim 20, wherein said first electroconductive portion and said second electroconductive portion are mounted to said second frame portion.

23. A process cartridge according to claim 20, wherein said first electroconductive portion and second electroconductive portion include comb-like portions interraced with each other with gaps.

24. An electrophotographic image forming apparatus for forming an image on the recording material, to which a process cartridge is detachably mountable, said apparatus comprising:
(a) a main assembly cartridge contact;
(b) mounting means for mounting a process cartridge, said process cartridge including;
an electrophotographic photosensitive member;
a developing member for developing an electrostatic latent image forming on said electrophotographic photosensitive member;
a developing device frame including a first frame portion supporting said developing member and d second frame portion having a developer accommodating portion for accommodating a developer to be used for developing the electrostatic latent image by said developing member;
first and second electroconductive portions disposed spaced from each other to detect, by the main assembly of the apparatus, a remaining amount of the developer in said process cartridge;
an cartridge contact, disposed in said first frame portion, for electrical connection with the main assembly of the apparatus when the process cartridge is mounted to the main assembly of the apparatus;
a contacting electrode disposed in said first frame portion and electrically connected with said first cartridge contact;
a first electroconductive portion contact disposed in said second frame portion and electrically connected with said first electroconductive portion;
wherein said first electroconductive portion contact and said contacting electrode are contacted with each other at a connecting portion between said first frame portion and said second frame portion.
